(19) United States
(12) Patent Application Publication
(10) Pub. No.: US 2026/0355052 A1
(43) Pub. Date: Nov. 12, 2026

(54) Penis Enlargement Device

(71) Applicant: Baseem Najjar, Lewes, DE (US)

(72) Inventor: Baseem Najjar, Lewes, DE (US)

(21) Appl. No.: 19/746,448

(22) Filed: Jul. 17, 2026

Related U.S. Application Data
(63) Continuation-in-part of application No. 18/582,593, filed on Feb. 20, 2024.

(51) Int. Cl. A61H 19/00; A61H 9/00

(52) U.S. Cl. CPC A61H 19/32; A61H 9/0057; A61H 2201/0107; A61H 2201/1238; A61H 2201/501; A61H 2201/5071; A61H 2201/5097

(57) ABSTRACT

A removable vacuum pump head for interchangeable anatomical vacuum cylinders includes a housing, a projecting coupling neck, and a fluid passage terminating at or within a cylinder chamber. A pump, pressure sensor, and controllable pressure-release valve communicate with the passage through a compact manifold that limits fluid volume between the chamber and pressure-control components. A controller locally executes stored multi-stage vacuum profiles in response to sensed pressure. Profiles may be received from a mobile device and may continue after wireless disconnection. Opposed support interfaces receive a strap or harness to support the assembled head and cylinder without continuous hand support. The pump head may operate with gas or with liquid present in the cylinder using a liquid barrier, separator, detector, or liquid-compatible wetted circuit. Interchangeable adapters permit transfer of the pump head among cylinders having different dimensions or coupling configurations.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIAL SUBMITTED ELECTRONICALLY

Not applicable.

### BACKGROUND OF THE INVENTION

### Field of the Invention

The present disclosure relates generally to vacuum devices for applying controlled negative pressure to anatomical tissue and, more particularly, to a removable powered pump head for interchangeable penile vacuum cylinders, the pump head having a compact cylinder coupling, programmable pressure control, dual gas-and-liquid operating capability, and support interfaces for hands-free use.

### Description of Related Art

Vacuum cylinders are used in sexual-wellness, conditioning, rehabilitation, and other anatomical vacuum applications. A conventional assembly may include a transparent cylinder, a body-contact seal, and a manual bulb or powered pump connected to the cylinder by a hose or an end fitting. Such arrangements may require continuous hand operation, may provide limited pressure repeatability, and may include an appreciable fluid volume between the cylinder chamber and the pump or pressure sensor.

Some powered devices mount a motorized pump directly to a cylinder. Direct mounting can reduce loose components, but a pump may still be dedicated to a particular cylinder, may provide only basic on-off operation, or may lack a practical support structure for stabilizing the combined weight of the pump and cylinder during an extended session.

Automatic devices may cycle pressure according to stored routines, and connected devices may permit remote control or data transfer. Nevertheless, remote control alone does not necessarily provide rapid local safety action, continued operation after a wireless interruption, or convenient reuse of one pump head with cylinders of different dimensions.

Liquid-assisted operation presents additional design concerns. A cylinder may contain water while electrical components are intended to remain unsubmerged. Liquid may therefore need to be separated, blocked, detected, drained, or transported through a protected wetted circuit. Cleaning and replacement of wetted components may also be desirable.

Accordingly, there remains a need for a compact and transferable vacuum pump head that provides a short chamber-to-control fluid path, local closed-loop execution of configurable pressure profiles, support for gas and liquid-containing sessions, and balanced hands-free support while remaining adaptable to multiple cylinders.

### BRIEF SUMMARY OF THE INVENTION

In one aspect, a removable vacuum pump head includes a housing and a coupling assembly projecting from a cylinder-facing side of the housing. The coupling assembly releasably engages a complementary coupling structure of a vacuum cylinder or an adapter attached to the cylinder. A fluid passage extends through the coupling assembly to a distal opening positioned at or within a chamber of the cylinder when the pump head is installed.

A vacuum pump, a pressure sensor, and a controllable pressure-release valve communicate with the fluid passage through a manifold contained by the housing. Positioning the distal opening and manifold near the cylinder interface provides a compact chamber-to-manifold path and reduces fluid volume that otherwise would be present in an external hose, remote fitting, or enlarged intermediate cavity.

A controller locally executes one or more stored multi-stage vacuum profiles. The controller receives pressure measurements from the pressure sensor and operates the vacuum pump and pressure-release valve to establish successive ramp, hold, release, recovery, or other segments. Each segment may specify one or more of a target negative pressure, permitted pressure band, ramp rate, duration, release amount, recovery pressure, motor speed, duty cycle, transition condition, or repetition count.

A profile may be selected using local controls or received wirelessly from an external computing device. After receipt, the profile may be stored and executed within the pump head without requiring a continuously active wireless connection. The external computing device may be used to create, combine, save, or review custom profiles and custom settings and to display or store session information.

The housing may include first and second load-support interfaces on opposing sides of a coupling axis. A strap, harness, garment attachment, or fixed support can connect to the interfaces and support at least part of the weight of the assembled pump head and cylinder. Opposed support locations can reduce rotation and reduce the need for continuous hand support.

The pump head may be selectively transferred among cylinders having different lengths, diameters, or coupling configurations. A common coupling interface may be provided on the cylinders, or respective adapters may convert different cylinder interfaces to a common pump-head interface. An adapter may remain attached to a cylinder when the pump head is transferred to another cylinder.

In a gas operating mode, the pump withdraws gas from the cylinder chamber. In a liquid-containing mode, liquid may occupy at least part of the chamber while the pump withdraws gas from a headspace. A separator, trap, hydrophobic barrier, float valve, tortuous passage, liquid detector, or other liquid-management device may protect a dry pump and electronic components.

In another liquid-containing embodiment, a liquid-compatible pump and wetted circuit transport gas, liquid, or a gas-liquid mixture. Wetted components may be isolated from the controller, battery, wireless module, and other protected electronics. A removable wetted insert or cartridge may facilitate drainage, cleaning, and replacement.

Safety features may include a stored negative-pressure limit, an independently enforced cutoff, automatic pressure release, maximum pump runtime, manual release, sensor plausibility monitoring, leak detection, motor-current monitoring, low-battery response, moisture detection, and a predetermined response to loss of communication.

Methods are also disclosed for selecting and attaching one of multiple cylinders, executing a locally stored pressure profile under pressure feedback, supporting the assembled device through opposed load-support interfaces, operating with gas or liquid present in the cylinder, recording session information, releasing vacuum, detaching the pump head, and cleaning removable wetted components.

The foregoing summary is illustrative and is not intended to identify every embodiment or limit the scope of the claims. Features described in connection with one embodiment may be combined with features of another embodiment unless technically incompatible.

### BRIEF DESCRIPTION OF THE DRAWINGS

FIG. 1 is a front elevational view of an example removable vacuum pump head showing a display, local controls, a manually operable vacuum-release actuator, and opposed load-support interfaces.

FIG. 2 is a rear elevational view of the pump head of FIG. 1, showing the housing, a charging interface, the manually operable vacuum-release actuator, the opposed load-support interfaces, and a projecting coupling assembly.

FIG. 3 is an elevation view of a modular system in which the pump head is selectively couplable to first and second anatomical vacuum cylinders having different chamber dimensions through respective coupling interfaces or adapters.

FIG. 4 is an exploded view of the pump head, a seal, an optional adapter, and the vacuum cylinder.

FIG. 5 is an enlarged schematic sectional view of the coupling assembly and a compact chamber-to-manifold fluid path.

FIGS. 6A and 6B are schematic sectional views of respective direct-thread and adapter-based coupling arrangements.

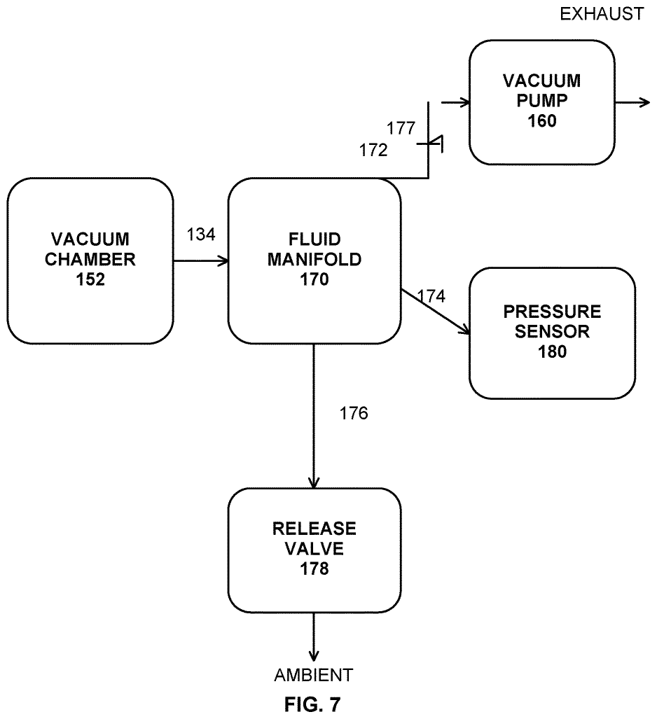

FIG. 7 is a fluid schematic of a pump, manifold, pressure-sensing branch, pressure-release branch, pressure-release valve, and optional check valve.

FIGS. 8A and 8B are fluid schematics of a protected dry-pump liquid-containing embodiment and a liquid-compatible wetted-circuit embodiment, respectively.

FIG. 9 is an electrical block diagram of a controller, memory, wireless module, battery, user interface, pressure sensor, pump, and valve.

FIGS. 10A and 10B are, respectively, a graph of an example multi-stage pressure profile and a control-flow representation of local closed-loop execution of the profile.

FIG. 11 is a schematic view of an assembled system supported by a strap connected to opposed load-support interfaces.

### DETAILED DESCRIPTION OF THE INVENTION

The following description uses directional terms such as front, rear, upper, lower, distal, and proximal for convenience in describing illustrated orientations. The terms do not require a particular orientation in use. A component described in the singular may include one or more such components, and a recited connection may be direct or may include one or more intervening components unless the context requires otherwise.

As used herein, “negative pressure” means pressure below ambient pressure. A stated pressure may be expressed as an absolute pressure, a gauge pressure, or a magnitude of vacuum. “Fluid” includes a gas, a liquid, or a mixture thereof. “Anatomical vacuum cylinder” means a chamber-forming member configured to receive penile tissue or other selected anatomical tissue while negative pressure is applied. “Dead space” means fluid volume outside the principal cylinder chamber that is evacuated or displaced as chamber pressure changes.

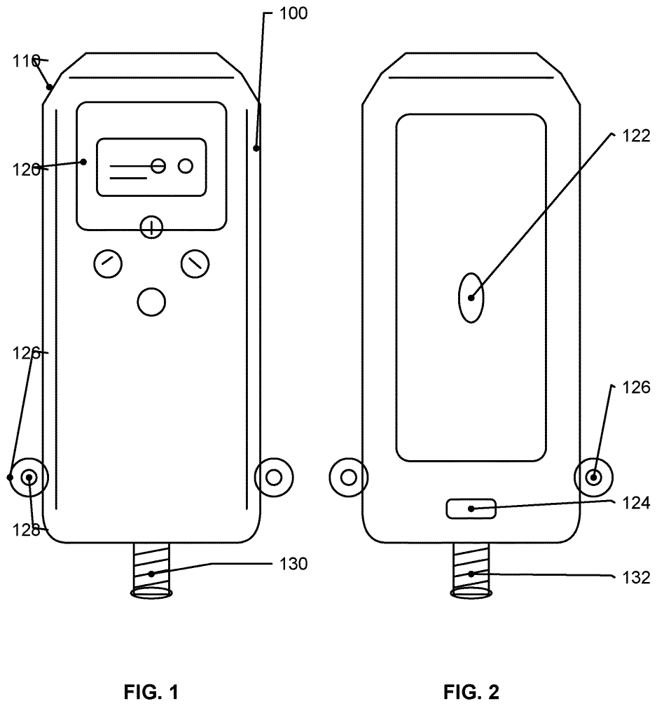

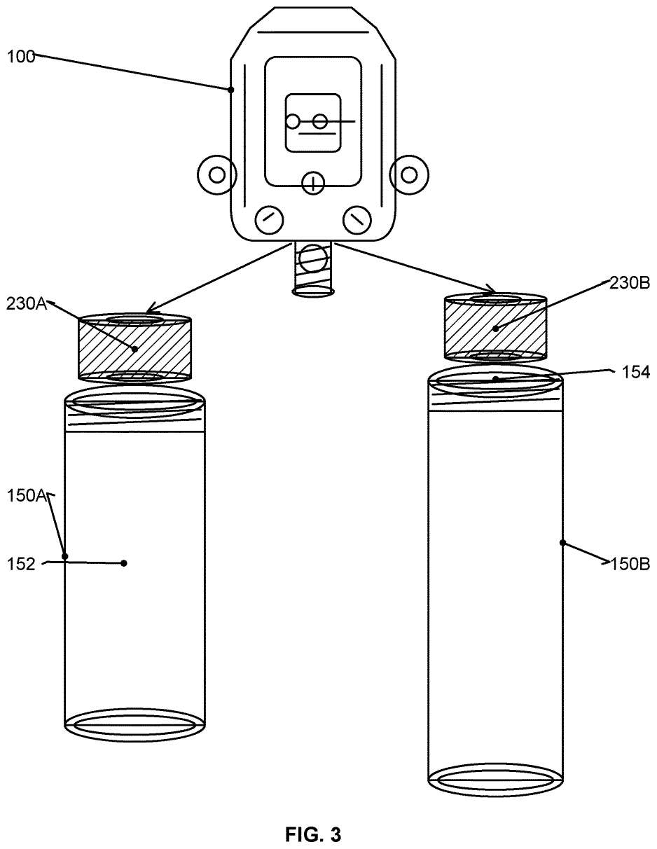

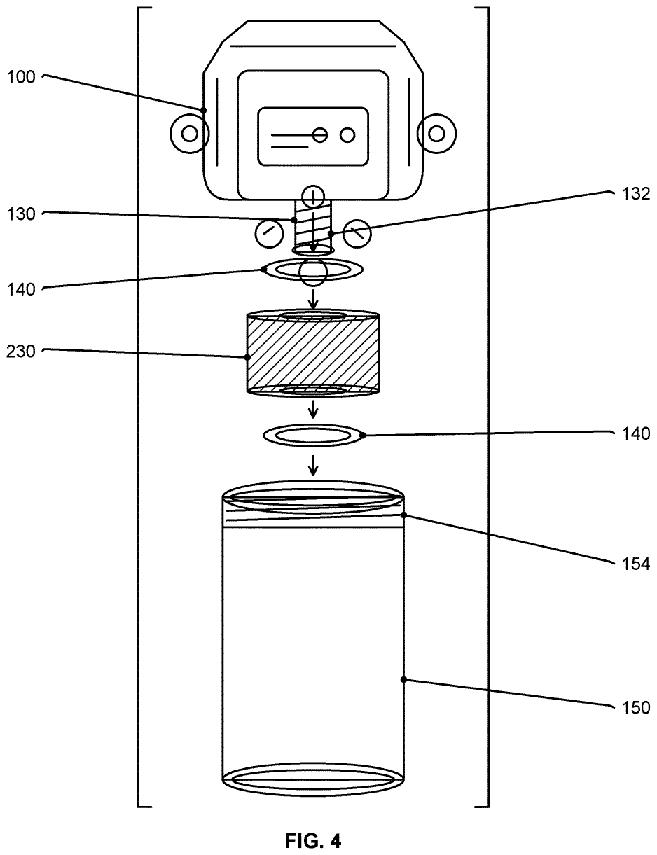

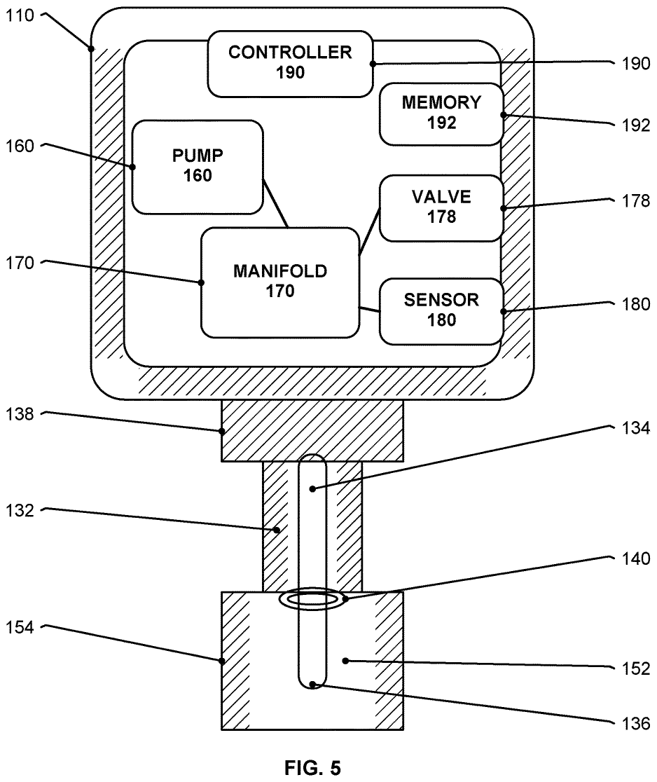

Referring to FIGS. 1-4, a vacuum pump head 100 includes a housing 110, a display and local-control assembly 120, a manually operable vacuum-release actuator 122, a charging interface 124, first and second support lugs 126, and a coupling assembly 130. FIG. 3 illustrates the pump head 100 selectively couplable to first and second vacuum cylinders 150A and 150B, each defining a vacuum chamber 152 and having a cylinder coupling interface 154, optionally through respective adapters 230A and 230B. FIG. 4 illustrates a representative vacuum cylinder 150 and adapter 230.

The housing 110 may be formed from one or more molded polymer shells, machined components, overmolded components, or combinations thereof. Internal walls, gaskets, sealants, potting, or separate compartments may isolate fluid-contact components from a controller, battery, display, and wireless electronics. The housing may be splash resistant without being configured for complete submersion.

The display and local-control assembly 120 may include a segmented display, liquid-crystal display, organic light-emitting display, indicator lights, membrane keys, mechanical buttons, capacitive controls, a rotary control, or combinations thereof. Displayed information may include measured pressure, target pressure, elapsed time, remaining time, profile identifier, operating segment, battery condition, wireless status, liquid condition, and warning information. Pressure may be displayed in one or more selectable units.

The charging interface 124 may include a USB connector, an inductive charging receiver, charging contacts, or a removable battery interface. A movable cover, elastomeric plug, gasket, or internal seal may protect the charging interface against incidental moisture. Charging may be disabled during a session or when moisture is detected.

The support lugs 126 are positioned on opposite side portions of the housing 110. Each support lug may define an aperture 128 for receiving a strap end, clip, ring, hook, cord, buckle, or other connector. The lugs may be integral with a housing shell, attached to an internal frame, or coupled to a load-bearing member that transfers support force around protected internal components.

The support lugs 126 may be arranged substantially symmetrically about a coupling axis of the coupling assembly 130. A line or resultant force between support connections may pass through or near the coupling axis, thereby limiting torque that would otherwise tilt or rotate the pump head and cylinder. In other embodiments, the support interfaces are asymmetrical to accommodate a selected wearing orientation or route a strap away from a display.

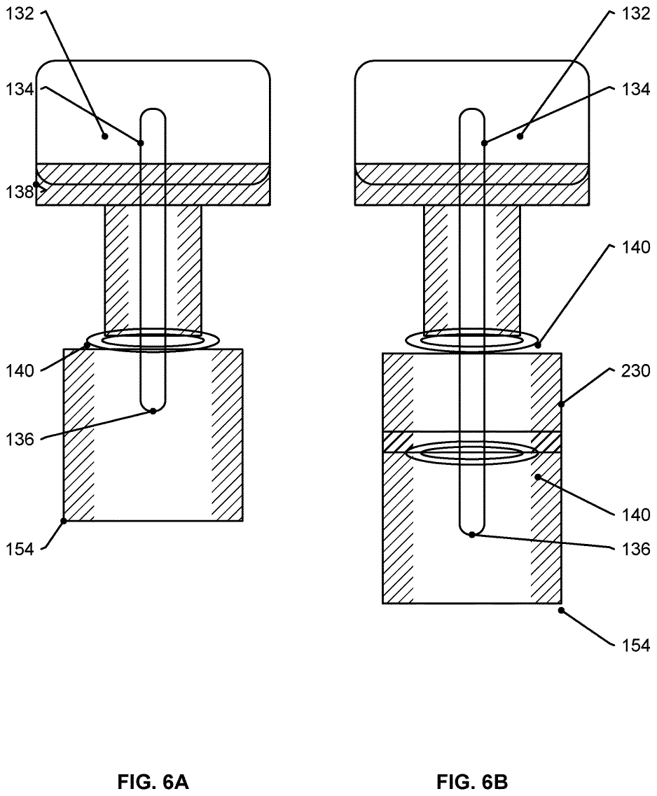

Referring to FIGS. 4 and 5, the coupling assembly 130 includes a projecting tubular neck 132 defining an axial fluid passage 134 and terminating at a distal fluid opening 136. The coupling assembly may further include an annular shoulder 138 and a seal 140. The neck 132 may carry an external thread configured to engage an internal thread of the cylinder coupling interface 154 or an interchangeable adapter 230.

When the coupling assembly 130 is installed, the distal fluid opening 136 may be positioned at a seal plane, beyond the seal plane, or within the vacuum chamber 152. The seal 140 may be compressed axially against an end face or radially between overlapping cylindrical surfaces. The seal may be an O-ring, gasket, molded lip, face seal, radial seal, or another reusable or replaceable sealing element.

The axial fluid passage 134 extends through the projecting neck 132 toward a fluid manifold 170 within the housing. By extending the passage to or into the chamber and locating the manifold near the neck, the assembly limits the fluid volume between the chamber 152 and active pressure-control components. The resulting compact path may reduce the quantity of gas or liquid that must be moved before chamber pressure changes, reduce sensor lag, and reduce residual fluid retained in an intermediate connector.

The reduced-volume arrangement is structural and does not require a particular percentage reduction. In various embodiments, the chamber-to-manifold path excludes an external flexible vacuum hose, an external pump bulb, and an enlarged remote coupling cavity. A reference arrangement for comparison may include a hose-connected pump or a recessed pump port separated from the chamber by an extended conduit.

The coupling assembly 130 may be removable from the housing as a service component or wetted insert. Alternative couplings include an internal thread, bayonet connection, quarter-turn connection, snap fit, latch, clamp, detent, magnetic coupling with a mechanical safety retainer, or another releasable fluid-tight connection. The projecting neck may be circular, oval, polygonal, keyed, or otherwise shaped.

The adapter 230 may include a pump-head side having a standardized interface and a cylinder side selected for a particular cylinder. Multiple adapters may have different thread pitches, thread diameters, sealing locations, or non-threaded interfaces while presenting the same pump-head interface. An adapter can include a short internal passage arranged to preserve the compact chamber-to-manifold path.

Referring to FIG. 3, a modular system may include a first cylinder 150A and a second cylinder 150B having different chamber lengths, diameters, shapes, body-contact seals, materials, or graduations. The first and second cylinders may carry respective adapters 230A and 230B that present a common pump-head coupling configuration. One pump head 100 may be moved between the cylinders. In some embodiments, each cylinder retains its adapter so that transfer requires only disengaging the head from one common interface and engaging the head with another.

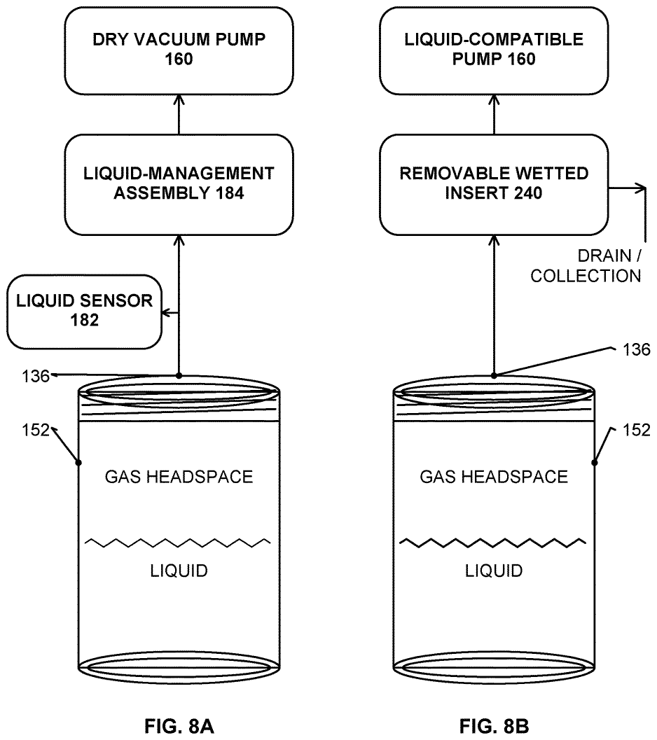

Referring to FIG. 7, the fluid manifold 170 may include an evacuation branch 172, a pressure-sensing branch 174, and a pressure-release branch 176. The branches communicate with the axial fluid passage 134 at a junction located within the housing adjacent the coupling assembly. The evacuation branch communicates with an inlet of a powered pump 160, the sensing branch communicates with a pressure sensor 180, and the pressure-release branch communicates with a controllable pressure-release valve 178.

The powered pump 160 may be a diaphragm pump, piston pump, peristaltic pump, rotary vane pump, piezoelectric pump, liquid-compatible pump, or other electrically driven pressure-reduction device. A motor driver may control pump on-time, speed, torque, direction, duty cycle, or current. An exhaust passage may discharge fluid to ambient or to a collection component.

The controllable pressure-release valve 178 may be a solenoid valve, proportional valve, pinch valve, motor-driven valve, piezoelectric valve, or another valve controlled by the controller. The pressure-release valve may admit ambient gas to the chamber, route fluid to a reservoir, or selectively connect the chamber to another pressure region. The manually operable vacuum-release actuator 122 may mechanically open the same valve or a separate relief valve.

An optional check valve 177 may inhibit reverse flow through the pump. A mechanical vacuum-limiting valve may open at a selected pressure independently of the controller. A flow restrictor may limit the rate at which vacuum is increased or released. The manifold may be formed by tubing, molded passages, a manifold block, a layered fluidic plate, or a replaceable cartridge.

The pressure sensor 180 may be an absolute, gauge, differential, piezoresistive, capacitive, optical, or other pressure sensor. A sensor inlet may be positioned close to the junction with the axial fluid passage to reduce delay associated with a long sensing line. The controller may filter, average, calibrate, temperature-compensate, or plausibility-check sensor output.

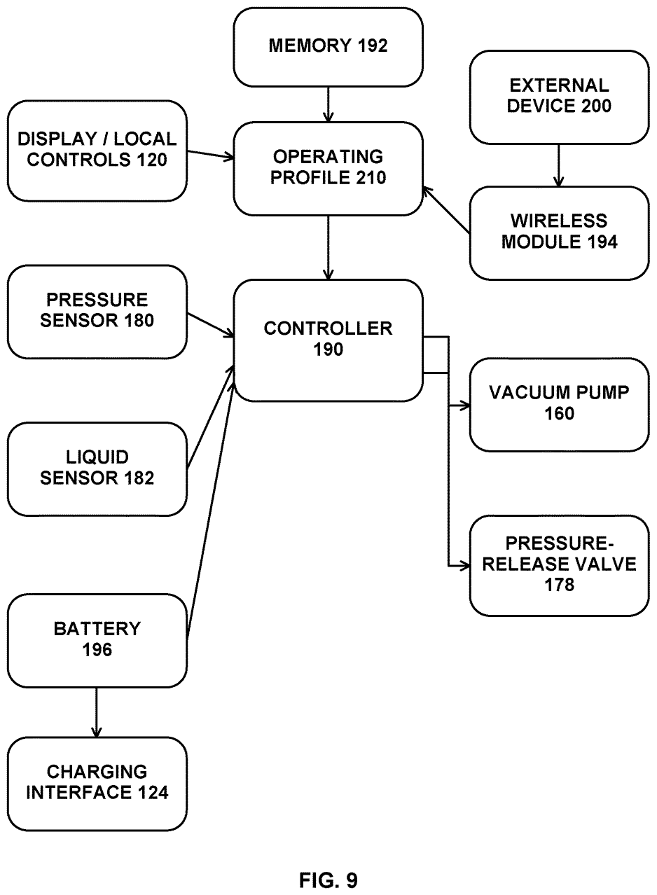

In the protected dry-pump embodiment of FIG. 8A, water or another liquid may occupy part of the chamber 152 while a gas headspace remains near the distal opening 136. The pump withdraws gas from the headspace. A liquid-management assembly 184 between the chamber and the pump inhibits liquid from reaching a pump not intended to transport liquid.

The liquid-management assembly 184 may include one or more of a collection trap, separator, hydrophobic membrane, float-operated shutoff, tortuous channel, capillary break, absorbent element, baffle, one-way valve, or liquid sensor 182. Detection of liquid may cause the controller to stop the pump, open the pressure-release valve, issue an alert, store an event record, or require drainage before restarting.

In the liquid-compatible embodiment of FIG. 8B, the powered pump 160 and at least part of the manifold are formed from materials and structures suitable for contact with water. The pump may withdraw gas, liquid, or a gas-liquid mixture from the chamber. A discharge separator may separate liquid from gas, and discharged liquid may enter a collection chamber or drain outlet.

A removable wetted insert 240 may define the axial fluid passage, one or more manifold branches, a separator, and one or more seals. The insert may be detached without opening an electronics compartment and may be rinsed, disinfected, dried, or replaced. A keyed interface may prevent incorrect insertion, and a sensor or switch may confirm that the insert is installed before pump operation.

Wetted surfaces may be formed from stainless steel, silicone, fluoropolymer, polypropylene, polycarbonate, acrylonitrile butadiene styrene, thermoplastic elastomer, or another material selected for strength, sealing, chemical compatibility, and cleanability. Protected electronics may be enclosed by welded shells, gaskets, conformal coatings, potting compounds, or internal barriers.

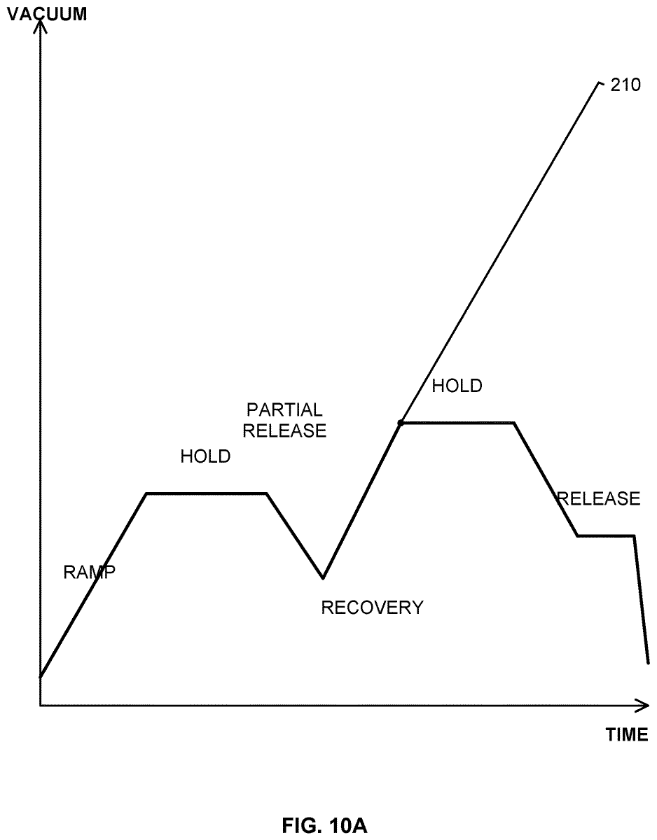

Referring to FIG. 9, the pump head includes a controller 190, memory 192, wireless module 194, and battery 196. The controller may include one or more microcontrollers, processors, application-specific circuits, or programmable logic devices. The memory may store firmware, calibration data, user settings, operating profiles, session records, identifiers, and safety parameters.

The controller 190 communicates with the pressure sensor 180, powered pump 160, pressure-release valve 178, display and local-control assembly 120, battery-management circuitry, and optional liquid sensor 182. The controller may sample pressure at a fixed or adaptive interval and may control the pump and valve using on-off, pulse-width, proportional, proportional-integral-derivative, model-based, predictive, or other feedback logic.

An operating profile 210 includes a sequence of two or more segments. A segment may command pressure increase, pressure maintenance, partial release, full release, recovery, pause, or termination. A segment may begin when a preceding time expires, when pressure reaches a threshold, when pressure stabilizes, when a cycle count is met, or when a user command or safety event occurs.

Profile parameters may include a target negative pressure, upper and lower pressure boundaries, ramp rate, pump speed, pump duty cycle, hold duration, release pressure, release duration, recovery pressure, cycle count, maximum session duration, leak tolerance, sensor sampling rate, and transition rule. Different parameter subsets may be used in different embodiments.

The memory 192 may contain a plurality of factory profiles, including progressive, pulsed, interval, steady-hold, recovery, or user-training modes. The number and labels of profiles are not limiting. A user may select a profile locally and may adjust only permitted parameters within stored safety boundaries.

The local-control assembly 120 may permit the user to power the pump head, choose a pressure unit, select a profile, set a target pressure, start, pause, resume, release, or stop a session, and review selected data. The pump head may therefore be fully operable without an external computing device.

The wireless module 194 may communicate with a mobile telephone, tablet, computer, remote control, or other external computing device 200. Communication may use Bluetooth, Bluetooth Low Energy, Wi-Fi, near-field communication, an optical link, or another wireless protocol. A wired data interface may additionally or alternatively be used.

An application executed by the external computing device 200 may provide a profile editor. The editor may permit a user to arrange or stack segments and set maximum pressure, hold time, pressure drop, recovery pressure, repetitions, and motor speed. The resulting parameter set may be saved as custom settings or as a custom profile. The application may validate the profile against device capabilities and safety constraints before transferring the profile to the pump head.

After transfer, the controller 190 may store the profile in memory 192 and execute it locally. A wireless connection may then be discontinued without interrupting the profile. Local execution reduces dependence on communication latency and permits safety actions to be performed by the pump head even if the external device is unavailable.

The pump head or external computing device may record a session start time, duration, selected profile, pressure samples, maximum pressure, average pressure, completed segments, completed cycles, user pauses, manual releases, automatic releases, liquid detections, communication interruptions, low-battery events, and other operating events. Records may remain local, may be exported, or may be synchronized with user authorization.

A cylinder or adapter may include a machine-readable identifier, resistor, magnet pattern, radio-frequency identifier, optical code, or other identifier. The pump head may use the identifier to select compatible profiles, modify allowable limits, apply calibration data, or record which cylinder was used. In the absence of an identifier, cylinder information may be selected manually.

Safety limits may be stored separately from user-editable profile data. The controller may refuse a profile that exceeds a maximum pressure magnitude, ramp rate, duration, repetition count, or motor condition. The controller may also impose a lower limit for a particular cylinder identifier or liquid mode. Numerical values may be selected by the manufacturer or clinician and are not limited by this disclosure.

A separate hardware comparator, watchdog, mechanical relief valve, independent firmware task, or redundant pressure sensor may enforce a safety condition independently of the primary profile routine. The manually operable vacuum-release actuator 122 remains accessible while the assembly is supported by a strap. Activation may equalize chamber pressure even when the controller or battery is unavailable.

Abnormal-condition logic may detect an implausible sensor signal, insufficient pressure change while the pump operates, excessive pressure decay while the pump is stopped, a blocked vent path, excessive motor current, pump stall, overheating, low battery, missing wetted insert, unexpected liquid, or a housing-open condition. A detected condition may stop the pump, vent the chamber, alert the user, and store an event record.

Communication loss may be handled according to a selected policy. A locally stored profile may continue while local safety controls remain active, or the controller may pause and vent if the profile requires continuous supervision. A received remote command may be authenticated, time-limited, range-limited, or rejected when it would conflict with a local safety state.

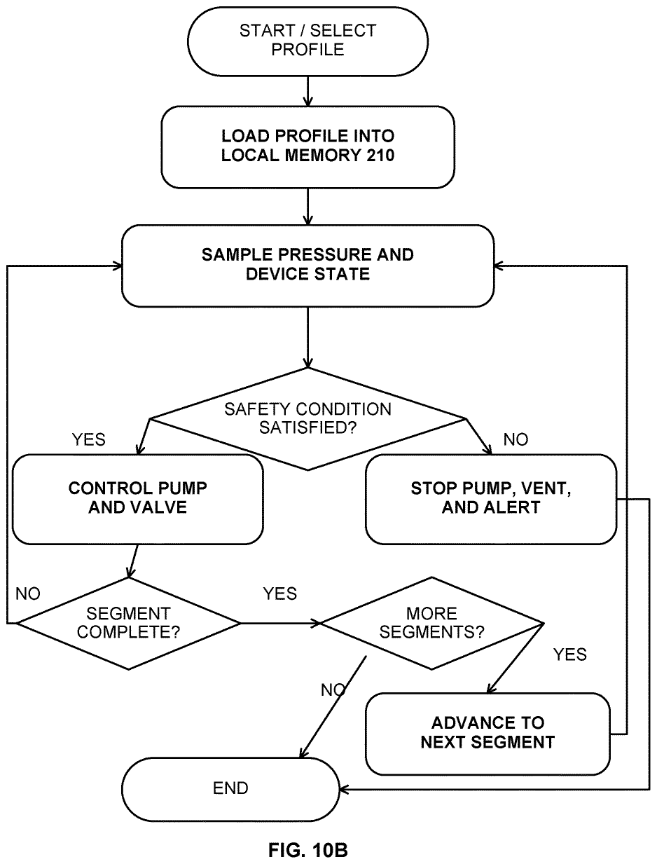

Referring to FIGS. 10A and 10B, an example closed-loop cycle begins with a ramp segment. The controller compares measured pressure with a target trajectory and operates the pump at a selected speed or duty cycle. As pressure approaches a target band, the controller may reduce pump output to limit overshoot. During a hold segment, the controller intermittently operates the pump to compensate for leakage.

During a partial-release segment, the controller opens the pressure-release valve until pressure reaches a recovery level and then closes the valve. A full-release segment may reduce chamber vacuum substantially to ambient pressure. Segments can be repeated according to a cycle count. The controller may adjust subsequent pump operation based on observed leakage, response time, or the difference between commanded and measured pressure.

Control hysteresis, filtering, minimum valve-open times, minimum pump-off times, adaptive gains, and predicted pressure response may be used to reduce oscillation. The controller may distinguish an intentional release from a poor body seal by reference to valve state, pressure slope, pump state, and elapsed time.

In an example gas-mode method, a user selects a cylinder, engages the coupling assembly with the cylinder or adapter, positions the open end of the cylinder against the body, selects a profile, and initiates operation. The controller evacuates gas through the compact fluid path, controls chamber pressure according to successive profile segments, and vents the chamber before removal.

In an example liquid-containing method, liquid is introduced into the cylinder before or after the cylinder is positioned. The pump head remains above or otherwise outside the surrounding liquid and is not submerged unless configured for submersion. The pump withdraws gas from a headspace or transports fluid through a liquid-compatible circuit while the liquid-management assembly protects sensitive components.

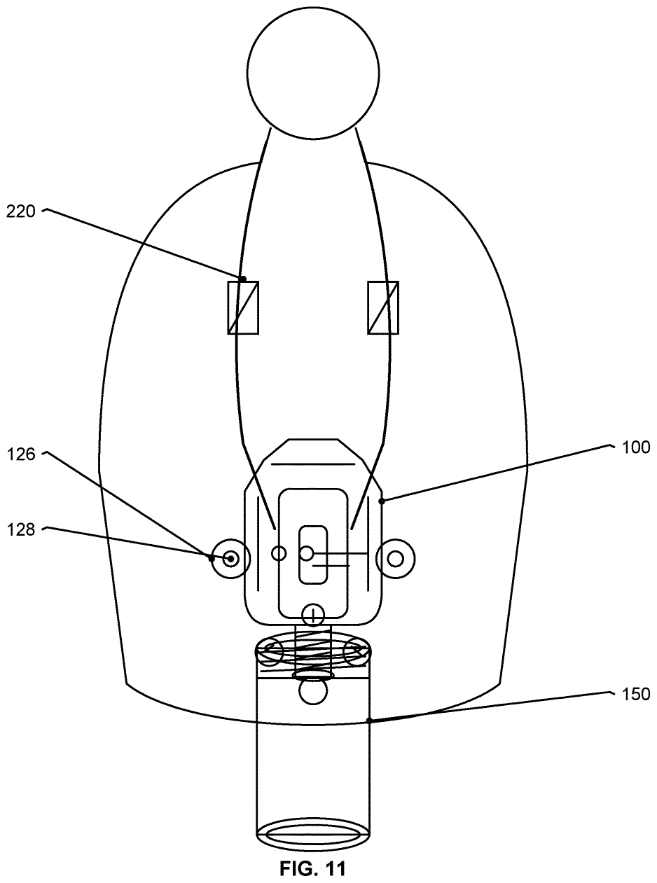

Referring to FIG. 11, a support member 220 is connected to the apertures 128 of the opposed support lugs 126. The support member may pass around a neck or shoulder, attach to a torso harness or garment, connect to a stand, or be suspended from a fixed support. Length-adjustment elements may position the cylinder while maintaining user access to the controls and manual release.

Loads from the support member 220 are introduced at two spaced locations on the housing. The housing or an internal frame distributes the loads around the coupling assembly. Supporting the assembly at opposing locations can reduce pendulum motion and can keep the cylinder substantially aligned with the coupling axis without requiring the user to continuously hold the pump head.

After use, the controller or user opens the pressure-release valve, the pump head is detached, and residual fluid is drained. A removable adapter, seal, trap, separator, or wetted insert may be removed. Wetted components may be rinsed and dried while the exterior of the electronic housing is wiped without submerging protected components. A seal may be inspected and replaced when worn.

The pump head may include a service mode that opens selected valves, briefly operates the pump, prompts drainage, or verifies sensor and valve function after cleaning. A storage configuration may cover the distal opening and charging interface. The application may provide cleaning reminders based on liquid mode, session count, or elapsed time.

The pump head may be assembled by installing the pump, manifold, sensor, valve, controller, battery, and wireless module into respective housing compartments, joining housing shells, attaching or inserting the coupling assembly, and calibrating the pressure sensor. A leak test may be performed with a test fixture attached to the coupling interface.

Although several embodiments use a single fluid passage through the projecting neck, another embodiment may include multiple passages, such as separate evacuation and vent passages, provided that the pump head remains removable and a compact cylinder-facing connection is maintained. A coaxial passage arrangement or a passage within an annular region may also be used.

The support interfaces need not be circular lugs. They may include slots, rails, recessed anchors, threaded inserts, magnetic connectors with mechanical retainers, rotating loops, or detachable clips. A support member may include a breakaway or load-limiting feature that releases above a selected force.

The wireless functions may be omitted, disabled, or restricted. The pump head may instead receive profiles through a wired connection or removable memory. Conversely, a network service may synchronize profiles or records, subject to authentication and user authorization. No cloud service is required for local pressure control or safety operation.

Terms such as “may,” “can,” “example,” and “in some embodiments” indicate optional features and do not imply that a feature is required. “Comprising” and similar open-ended terms do not exclude additional elements or acts. Numerical ranges include endpoints and subranges. Features described separately may be combined, and features described together may be used separately, to the extent technically compatible.

The scope of protection is defined by the claims rather than by the illustrated examples. Changes in form and detail may be made without departing from the claimed subject matter.

1. A removable vacuum pump head configured for coupling to an anatomical vacuum cylinder configured to receive penile tissue and defining a vacuum chamber, the pump head comprising:
a housing defining a cylinder-facing side;
a coupling assembly projecting from the cylinder-facing side along a coupling axis and including a coupling structure configured to releasably engage a complementary coupling structure of the anatomical vacuum cylinder or an adapter secured to the anatomical vacuum cylinder, the coupling assembly including a projecting neck that defines a fluid passage extending to a distal opening positioned at or within the vacuum chamber when the pump head is coupled to the anatomical vacuum cylinder;
a vacuum pump supported by the housing;
a controllable pressure-release valve supported by the housing;
a pressure sensor supported by the housing;
a fluid manifold contained by the housing and placing the vacuum pump, the controllable pressure-release valve, and the pressure sensor in fluid communication with the fluid passage;
a memory configured to store a multi-stage vacuum profile;
a controller contained by the housing and configured to locally execute a multi-stage vacuum profile stored in the memory by controlling the vacuum pump and the controllable pressure-release valve in response to pressure measurements generated by the pressure sensor; and
first and second load-support interfaces disposed on opposing sides of the coupling axis and configured to receive a support member for supporting at least a portion of a combined weight of the pump head and the anatomical vacuum cylinder,
wherein the distal opening and the fluid manifold are connected by a chamber-to-manifold fluid path located within the coupling assembly and the housing without an external flexible vacuum hose.

2. The vacuum pump head of claim 1, wherein the coupling structure comprises an external screw thread, the coupling assembly comprises an annular shoulder, and a replaceable annular seal is positioned to be compressed between the annular shoulder and the anatomical vacuum cylinder or the adapter.

3. The vacuum pump head of claim 1, wherein the coupling structure has a common pump-head configuration configured to releasably engage respective pump-head interfaces of a plurality of interchangeable adapters, the interchangeable adapters having mutually different cylinder interfaces for coupling to anatomical vacuum cylinders having different coupling configurations.

4. The vacuum pump head of claim 1, wherein the fluid manifold includes an evacuation branch, a pressure-sensing branch, and a pressure-release branch that communicate with the fluid passage at a junction adjacent the coupling assembly, the pressure sensor communicating with the junction through the pressure-sensing branch.

5. The vacuum pump head of claim 1, wherein the multi-stage vacuum profile includes a plurality of segments, each segment specifying at least one of a target negative pressure, a permitted pressure band, a ramp rate, a hold duration, a release pressure, a release duration, a recovery pressure, a pump speed, a pump duty cycle, a repetition count, or a transition condition.

6. The vacuum pump head of claim 1, further comprising a wireless communication module including a Bluetooth or Bluetooth Low Energy transceiver and configured to receive the multi-stage vacuum profile from an external computing device, wherein the controller is configured to store the received multi-stage vacuum profile in the memory and continue local execution of the received multi-stage vacuum profile after termination of a wireless connection with the external computing device.

7. The vacuum pump head of claim 1, wherein the controller is configured to enforce a stored safety limit independently of user-editable profile parameters and, in response to violation of the stored safety limit, stop the vacuum pump and open the controllable pressure-release valve, the pump head further comprising a manually operable vacuum-release actuator.

8. The vacuum pump head of claim 1, further comprising, between the distal opening and an inlet of the vacuum pump, at least one liquid-management component comprising at least one of a liquid trap, a gas-liquid separator, a hydrophobic barrier, a float-operated shutoff, a tortuous passage, a moisture sensor, or a liquid-responsive shutoff.

9. The vacuum pump head of claim 1, wherein the vacuum pump is liquid-compatible, and at least a portion of each of the fluid passage and the fluid manifold is defined by a removable wetted insert fluidically isolated from the controller and the memory.

10. A modular anatomical vacuum system comprising:
a first anatomical vacuum cylinder defining a first chamber;
a second anatomical vacuum cylinder defining a second chamber, at least one chamber dimension of the second chamber differing from a corresponding chamber dimension of the first chamber;
a first pump-head interface carried by the first anatomical vacuum cylinder or by a first adapter attached thereto, and a second pump-head interface carried by the second anatomical vacuum cylinder or by a second adapter attached thereto, the first and second pump-head interfaces having a common coupling configuration;
a removable pump head selectively couplable to either of the first and second pump-head interfaces, the removable pump head including a projecting neck defining a fluid passage, a vacuum pump, a pressure sensor, a controllable pressure-release valve, and a controller configured to control the vacuum pump and the controllable pressure-release valve in response to pressure measured through the fluid passage;
first and second support interfaces disposed on opposing side portions of the removable pump head; and
a support member having first and second ends configured to connect respectively to the first and second support interfaces,
wherein, when the removable pump head is coupled to a selected one of the first and second anatomical vacuum cylinders, a distal opening of the projecting neck is positioned at or within the chamber of the selected anatomical vacuum cylinder and the support member is configured to support at least part of a combined weight of the removable pump head and the selected anatomical vacuum cylinder.

11. The modular anatomical vacuum system of claim 10, wherein each of the first and second pump-head interfaces comprises a threaded interface, and the projecting neck includes a complementary thread and an annular seal.

12. The modular anatomical vacuum system of claim 10, wherein the first and second pump-head interfaces are provided respectively by the first and second adapters, each adapter being configured to remain attached to its corresponding anatomical vacuum cylinder while the removable pump head is transferred between the first and second anatomical vacuum cylinders.

13. The modular anatomical vacuum system of claim 10, wherein the vacuum pump is a dry vacuum pump, the selected anatomical vacuum cylinder contains liquid and a gas headspace, and the removable pump head further comprises a liquid-management assembly configured to inhibit liquid from reaching the dry vacuum pump while the dry vacuum pump withdraws gas from the gas headspace.

14. The modular anatomical vacuum system of claim 10, wherein the controller provides a selectable gas mode and a selectable liquid-containing mode for operation of the same removable pump head.

15. The modular anatomical vacuum system of claim 10, wherein the removable pump head is configured to store a session record including at least two of a session duration, a profile identifier, measured pressure data, a completed cycle count, a manual-release event, an automatic-release event, a liquid-detection event, or a safety event.

16. The modular anatomical vacuum system of claim 10, wherein the removable pump head includes a local display and local controls configured to select and execute a stored pressure profile without an external computing device.

17. A method of operating a modular anatomical vacuum system, the method comprising:
selecting, from a plurality of anatomical vacuum cylinders configured to receive penile tissue and having different chamber dimensions, a selected anatomical vacuum cylinder;
releasably coupling a removable pump head to the selected anatomical vacuum cylinder by engaging a projecting coupling assembly of the removable pump head with the selected anatomical vacuum cylinder or an adapter attached thereto such that a distal opening of the projecting coupling assembly is positioned at or within a chamber of the selected anatomical vacuum cylinder;
selecting or receiving a multi-stage vacuum profile;
measuring pressure in the chamber through a fluid path extending through the projecting coupling assembly and the removable pump head without an external flexible vacuum hose;
locally controlling, by a controller of the removable pump head and in response to the measured pressure, a vacuum pump and a controllable pressure-release valve to perform successive segments of the multi-stage vacuum profile;
enforcing, by the removable pump head, a stored safety condition during performance of the multi-stage vacuum profile; and
opening the controllable pressure-release valve to reduce vacuum in the chamber before uncoupling the removable pump head from the selected anatomical vacuum cylinder.

18. The method of claim 17, further comprising receiving the multi-stage vacuum profile wirelessly from an external computing device, storing the multi-stage vacuum profile in memory of the removable pump head, and continuing local performance of the multi-stage vacuum profile after a wireless connection with the external computing device is terminated.

19. The method of claim 17, further comprising connecting a support member to first and second load-support interfaces positioned on opposing sides of a coupling axis of the removable pump head and supporting at least part of a combined weight of the removable pump head and the selected anatomical vacuum cylinder without continuous hand support.

20. The method of claim 17, further comprising operating with liquid present in the chamber and performing at least one of separating, blocking, detecting, or draining the liquid in a manner that inhibits the liquid from reaching protected electronic components of the removable pump head.
